(19) United States
(12) Patent Application Publication
(10) Pub. No.: US 2011/0139111 A1
(43) Pub. Date: Jun. 16, 2011

(54) METHOD FOR CONVERSION OF AN AIRCRAFT SPARK-IGNITION ENGINE AND AIRCRAFT ENGINE

(75) Inventor: Bernd STEPHAN, SCHWEINFURT (DE)

(73) Assignee: Bernd STEPHAN, SCHWEINFURT (DE)

(21) Appl. No.: 12/954,016

(22) Filed: Nov. 24, 2010

(30) Foreign Application Priority Data
Nov. 25, 2009 (DE) 10 2009 055 751.2

(51) Int. Cl. F02F 1/00; B23P 11/00

(52) U.S. Cl. 123/193.1; 29/401.1

(57) ABSTRACT

In the case of a method for conversion of an aircraft spark-ignition engine for driving a propeller, comprising a crankcase, a crankshaft, at least one cylinder having a cylinder head, a connecting rod and a piston, at least the cylinder with the cylinder head, possibly in conjunction with the piston, are replaced by corresponding components of a diesel engine, while retaining the crankcase, the crankshaft and/or the connecting rod.

The invention relates to a method for conversion of an aircraft engine, and to an aircraft engine.

Because of the operational conditions, an aircraft engine has to have a very high power density with a good power/weight ratio and a low propeller rotation speed. In this case, it should have a low specific fuel consumption and should be absolutely reliable (TBO (time between overhaul) >2000 h). These contradictory requirements, the small quantities, the high development costs and the legal certification requirements mean that numerous aircraft engines have been in use virtually unchanged for decades. The majority of modern high-performance aircraft piston engines, particularly from the major American manufacturers Lycoming, Continental and Rolls Royce still correspond to the technical standard in the early 1960s. Furthermore, on average, the present-day sports aircraft fleet is about thirty years old.

In addition, the majority of present-day aircraft spark-ignition engines are operated using AVGAS 100LL aircraft gasoline. This 100 octane fuel still has no alcohol. This fuel can no longer be obtained at many airfields and there are now still only a few manufacturers throughout the world. In contrast, Jet A1 kerosene is available at all airfields.

One object of the present invention is therefore to provide an aircraft engine and a method which, in particular, allow even relatively old aircraft and aircraft spark--ignition engines to be converted in a simple and cost-effective manner to diesel or kerosene operation.

The object is achieved by the subject matter of Claims 1 and 6. Advantageous refinements are described in the dependent claims.

According to claim 1, in the case of a method for conversion of an aircraft spark-ignition engine for driving a propeller, comprising a crankcase, a crankshaft, at least one cylinder having a cylinder head, a connecting rod and a piston, at least the cylinder with the cylinder head, possibly in conjunction with the piston, are replaced by corresponding components of a diesel engine, while retaining the crankcase, the crankshaft and/or the connecting rod.

In this case, the invention is based on the discovery that, in comparison to conversion to a water-cooled diesel engine with a step-down gearbox, which involves adaptation of a large number of components, which surround the engine and are connected to it, including the engine cowling, the engine mount and the propeller, and which is therefore correspondingly expensive and complex, the conversion according to the invention essentially requires no such adaptation and is therefore correspondingly simple and cost-effective. In the case of the conversion according to the invention, there is therefore advantageously no need for a life-critical step-down gearbox or water cooling, which increases the weight, wherein air-cooling, possibly in conjunction with oil cooling, in any case has the advantages of being lighter in weight and also of failure being virtually impossible, and this is particularly advantageous, in particular in respect of the legal regulations relating to redundancy. A further option is to provide only the cylinder heads with a small amount of water cooling, instead of oil cooling, with the cylinders still being air-cooled in this case.

In one advantageous refinement, the conversion is carried out in the course of a legally specified basic deep overhaul of the engine. A further major advantage of the diesel engine over an aircraft spark-ignition engine is in this case the considerably reduced fuel consumption. In this case, the consumption can even be reduced by up to 50%, for a comparable power. This makes it possible to compensate for the costs for deep overhaul with conversion, which are slightly greater than the costs of a deep overhaul without conversion, or even to more than compensate for this, thus resulting in amortization before the next deep overhaul. Furthermore, the reduced fuel consumption therefore advantageously reduces the environmental damage caused by emissions. Purely fundamentally, it would in this case also be possible to revert, to the aircraft spark-ignition during the next deep overhaul.

A further advantage of diesel engines is that—as the name implies—they can be operated with diesel or kerosene, for example Jet A or Jet A1, which is available at all airfields. In contrast, the availability of aircraft gasoline, to be precise AvGas and MoGas for aircraft spark-ignition engines is decreasing and is additionally subject to the obligations to add biofuels and alcohol, which can be problematic, in particular for relatively old types of aircraft spark-ignition engines.

The method according to the invention therefore provides a cost-effective conversion capability for the old sports aircraft fleet, which is about thirty years old on average, wherein these aircraft are generally overhauled for as long as the aircraft fuselage is serviceable, and this in the end leads to the fleet having a high average age.

Further advantages, features and details of the invention will become evident from the exemplary embodiment of the invention, as described in the following text, in conjunction with the figures, in which:

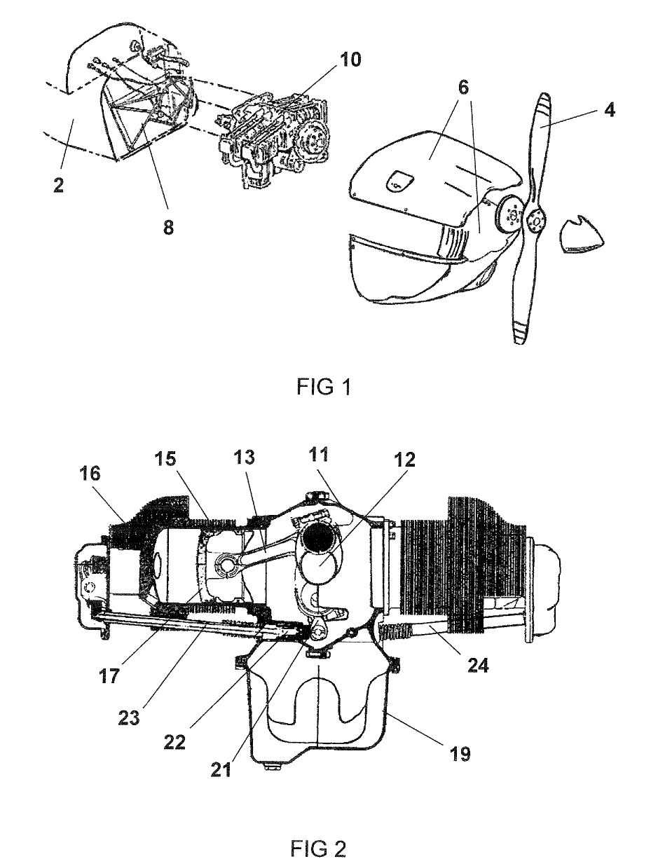

FIG. 1 shows a perspective illustration, in the form of an exploded drawing, of an aircraft engine in its installation environment, and

FIG. 2 shows a front view of an aircraft spark-ignition engine as an air-cooled 4-cylinder flat engine, with the left-hand half of the figure being in the form of a cross section through one of the cylinders.

FIG. 1 shows a perspective illustration, in the form of an exploded drawing, of how the actual engine 10 in a sports aircraft, and fitted at the nose of the sports aircraft fuselage 2, is connected via an engine mount structure 8 to the rest of the sports aircraft, and what further parts are connected to the engine 10, and surround it. In particular, the propeller 4 may be mentioned in this context, as well as upper and lower engine cowlings 6. The illustrated engine 10 is an air-cooled 4-cylinder flat engine. In the vast majority of the sports aircraft being operated, this engine 10 is in the form of a spark-ignition engine, which needs aircraft gasoline for operation.

FIG. 2 shows a front view of the aircraft spark-ignition engine 10, which is in the form of an air-cooled 4-cylinder flat engine, with the left-hand half of the figure being in the form of a cross section through one of the cylinders 15 of the engine 10. In this case, a crankshaft 12 is mounted such that it can rotate in a crankcase 11, on which crankshaft 12 our connecting rods 13 act, when the engine is in the form of a 4-cylinder engine, each of which connecting rods 13 is connected to a corresponding piston 17 in one of the four cylinders 15 of the engine 10. An oil sump 19 is arranged under the crankcase 11. Inlet and outlet valves are arranged in the cylinder heads 16 of each of the four cylinders 15, as are corresponding ignition devices when the engine 10 is in the form of a spark-ignition engine, by means of which a gasoline/air mixture can be ignited in order to move the piston 17. In this case, the valves in the cylinder heads 15 can he controlled via a camshaft 21, which is connected to the crankshaft 12 and operates the valves via hydraulic valve tappets 22 and push rods 23, which are arranged in push rod tubes 24. In this case, the camshaft may, of course, also he located at the top in other types of engine.

According to the invention, at least the cylinders 15 with the cylinder heads 16 and the pistons 17 of the aircraft spark-ignition engine are replaced by corresponding components of a diesel engine, in particular in the course of a legally required deep overhaul of the engine 10, wherein the crankcase 11, the crankshaft 12 and the connecting rods 13, as well as the camshaft 21, the push rod tubes 24 and the push rods 23 can advantageously remain substantially unchanged. This particularly Advantageously allows the engine mount structure 8, and therefore also the components of the diesel engine, to be kept in the same order of magnitude as the original engine dimensions, with the engine cowlings 6 remaining substantially unchanged, as a result of which this type of conversion results in a correspondingly advantageous cost position. Even the propeller 4 is retained unchanged.

Only the tank feed line need be correspondingly cleaned and converted to diesel operation. Instead of the previous magnetos, a corresponding diesel injection system is used in this case, wherein the injection means should be mechanically configured directly, and with the sense of a low failure probability, in which case, common rail is also possible. Furthermore, glow plugs have to be provided in the new cylinder head which, inter alia, allow the engine to he restarted at relatively high altitudes. The new diesel piston can in this case be designed, in comparison to the previous spark-ignition engine piston, to have a specially designed impression or cavity at its cylinder-head end, and to have cooling channels on the opposite side, into which oil for cooling can be sprayed from a nozzle which is arranged in the cylinder. In this case, oil cooling can also be provided for the cylinder heads. In this case, the oil is in turn cooled by an air-cooled oil cooler. The new diesel piston as well as the new cylinder may in this case also be formed from steel, thus making it possible to considerably increase the life and the thermal compatibility, in comparison to the normal configuration of aircraft spark-ignition engines composed of aluminum. Because of the higher power density of a diesel engine in comparison to a spark-ignition engine, the swept volume can also be reduced for the same power during conversion, and this in turn has an advantageous effect on the fuel consumption.

By way of example, in one refinement, there is no need for the carburetor, which is normally arranged under the oil sump in an aircraft spark-ignition engine, and the induction area can be adapted to create space for a turbocharger, thus allowing the diesel engine to be designed and operated on a turbocharged basis. The turbocharger offers power advantages, particularly at relatively high altitudes where naturally aspirated engines lose a great deal of power, because of the low air pressure. Furthermore, a boost air cooler can be added to the turbocharger in order to thermally protect the engine and to achieve a further efficiency increase. The flat engine could also optionally be equipped with two smaller turbochargers for each cylinder side.

1. Method for conversion of an aircraft spark-ignition engine for driving a propeller, comprising a crankcase, a crankshaft, at least one cylinder having a cylinder head, a connecting rod and a piston, wherein, while retaining the crankcase, the crankshaft and/or the connecting rod, at least the cylinder with the cylinder head may be replaced, possibly in conjunction with the piston, by corresponding components of a diesel engine.

2. Method according to claim 1, wherein the crankcase, the crankshaft and the connecting rod remain substantially unchanged during conversion, and/or the aircraft spark-ignition engine has a camshaft with tappets and push rods, which remain substantially unchanged during conversion.

3. Method according to claim 1, wherein the cylinder, cylinder head and the piston are replaced; the conversion is carried out substantially free of adaptation to components which surround the engine, including an engine mount, an engine cowling and/or the propeller; and/or magnetos for the aircraft spark-ignition engine are removed for diesel injection, and/or the carburetor and induction area which are not required create space for a turbocharger.

4. Method according to claim 1, wherein the conversion is carried out in the course of a legally specified deep overhaul of the engine, and/or the engine is associated with a single-engine or multi-engine, light, small or sports aircraft.

5. Method according to one of claim 1, wherein the engine is in the form of an air-cooled flat engine; the engine is equipped with one or two fuel injection means, one or two turbochargers and/or one or two boost air coolers and the diesel engine is equipped with oil-cooled pistons and/or oil-cooled cylinder heads, and/or the diesel engine is equipped with at least one, in particular air-cooled, oil cooler.

6. Aircraft engine for driving a propeller, comprising a crankcase, a crankshaft, at least one cylinder with a cylinder head, a connecting rod and a piston, wherein the crankcase, the crankshaft and/or the connecting rod are originally associated with an aircraft spark-ignition engine, and the cylinder with the cylinder head, possibly in conjunction with the piston, are components of a diesel engine.

7. Aircraft engine according to claim 6, wherein the crankcase, the crankshaft and the connecting rod are originally associated with an aircraft spark-ignition engine, and/or the aircraft engine has a camshaft with tappets and push rods, which are originally associated with an aircraft spark-ignition engine.

8. Aircraft engine according to claim 6, wherein the cylinder, cylinder head and the piston are components of a diesel engine, and/or the engine is associated with a single-engine or multi-engine light, small or sports aircraft.

9. Aircraft engine according to claim 6, wherein the engine is in the form of an air-cooled flat engine; the engine has one or two diesel injection means, one or two turbochargers and/or one or two boost air coolers; the engine is equipped with oil-cooled pistons and/or oil-cooled cylinder heads; and/or the engine is equipped with at least one, in particular air-cooled, oil cooler.
